(19) United States
(12) Patent Application Publication
(10) Pub. No.: US 2013/0203958 A1
(43) Pub. Date: Aug. 8, 2013

(54) POLYOXYMETHYLENE COPOLYMERS

(71) Applicant: BASF SE, Ludwigshafen (DE)

(72) Inventors: Laurence Pottie, Koln (DE); Bernd-Steffen von Bernstorff, Wachenheim (DE)

(73) Assignee: BASF SE, Ludwigshafen (DE)

(21) Appl. No.: 13/756,758

(22) Filed: Feb. 1, 2013

Related U.S. Application Data
(60) Provisional application No. 61/593,876, filed on Feb. 2, 2012.

(51) Int. Cl. C08G 65/26

(52) U.S. Cl. CPC C08G 65/2609
USPC 528/405

(57) ABSTRACT

Specific polyoxymethylene copolymers are described with a weight-average molar mass (M_{W}) in the range from 5000 to 15 000 g/mol, and processes are described for producing these by polymerization of trioxane and optionally of comonomers in the presence of at least one cationic initiator and of at least one di(C₁₋₆-alkyl) acetal as regulator.

### CROSS-REFERENCE TO RELATED APPLICATIONS

This application claims benefit (under 35 USC 119(e)) of U.S. Provisional Application 61/593,876, filed Feb. 2, 2011, which is incorporated by reference.

### BACKGROUND OF THE INVENTION

The invention relates to polyoxymethylene copolymers with low molecular weight, processes for producing these, and their use.

Polyoxymethylene homo- or copolymers, also termed polyacetal or polyformaldehyde, or POM, are generally high-molecular-weight thermoplastics which exhibit high stiffness, low coefficients of friction, and excellent dimensional stability and thermal stability. They are therefore used in particular for producing precision-engineered parts.

Properties which make them advantageously useful for applications involving moldings are in particular high strength, hardness, and stiffness over a wide temperature range. Further processing takes place by way of example by way of injection molding at temperatures in the range from 180 to 230° C., or else by extrusion. Polyoxymethylene is produced by way of example by direct polymerization of formaldehyde or by cationic or transition-metal-centered cationic polymerization of trioxane. For stabilization, the end groups are often protected by etherification or esterification in order to inhibit depolymerization on exposure to acid or to thermal stress.

Another possibility for stabilization to counter the effect of acid and of thermal stress is the production of copolymers, for example by copolymerizing trioxane with 1,4-dioxane. For stabilization here, the unstable end groups are decomposed by hydrolysis to give formaldehyde. Typical copolymers are available by way of example with trademarks Hostaform® from Ticona/Celanese and Ultraform® from BASF SE.

The melting point of the homopolymer is typically about 178° C., and that of the copolymer is typically about 166° C.

Processes for producing polyoxymethylene homo- or copolymers are described by way of example in WO 2007/023187 and WO 2009/077415.

U.S. Pat. No. 6,388,049 relates to polyoxymethylene polymers with low molecular weight and to compositions comprising these.

Production examples 14 to 16 mention trioxane- and butanediol formal-based copolymers in which methylal was used as regulator. The amount of comonomer added in each case is 1.46 mol %, corresponding to about 4.4% by weight of butanediol formal. Number-average molar masses obtained are 1100, 5500, and 35 000 g/mol.

Polyoxymethylene is also used as binder for powder injection molding. Here, POM molding compositions filled with inorganic powders, in particular metal powders or ceramic powders, are processed by injection molding to give moldings, and the binder is then removed and the products are sintered. Since the high loading of the inorganic powders in the POM impairs flowability, it is necessary to use POM compositions which are very flowable, in order to keep the pressures required in the injection molding process within acceptable bounds.

The flowability of the POM could be improved by reducing molecular weight, or flow improvers could be added. A flow improver here should have very good miscibility with POM and exhibit rapid decomposition in an acid-gas atmosphere, in order to avoid defects in the desired moldings.

It is an object of the present invention to provide polyoxymethylene copolymers with reduced molecular weights which can be used as viscosity-modifying additive for polyoxymethylene homo- or copolymers with higher molecular weight.

The invention achieves the object through a polyoxymethylene copolymer with a weight-average molar mass (M_{W}) in the range from 5000 to 15 000 g/mol, preferably from 5000 to 10 000 g/mol, or from 6000 to 13 000 g/mol, with preference from 6000 to 9000 g/mol, or from 6500 to 11 000 g/mol, particularly preferably from 6500 to 8000 g/mol, in particular from 7000 to 7500 g/mol; characterized in that at least 90% by weight of which, based on the polymer, derives from trioxane and butanediol formal as monomers, with a proportion of butanediol formal based on the polymer, in the range from 0.5 to 4% by weight, preferably from 1 to 4% by weight, with preference from 2 to 3.5% by weight, in particular from 2.5 to 3% by weight.

In an alternative to which preference is given, the number-average molar mass (Mₙ) is with preference from 3000 to 6000 g/mol, particularly preferably from 3200 to 5000 g/mol, in particular from 3500 to 4100 g/mol. Within this molecular weight range, a particularly advantageous flow improvement is achieved for polyoxymethylene homo- or copolymers with higher molecular weight.

The use of a polyoxymethylene copolymer of the present invention with a proportion of butanediol formal, based on the polymer, in the range from 1 to 4% by weight, reveals higher crystallinity and higher hardness despite the low molecular weight, because of the proportion of comonomer, reduced in comparison with U.S. Pat. No. 6,388,049. This gives, for polyoxymethylene homo- or copolymers with higher molecular weight, despite good viscosity-reducing properties, advantageous hardness of these polymer mixtures and therefore advantageous mechanical properties for the application.

The molar masses can be determined here as described in the examples. The molecular weights are generally determined by way of gel permeation chromatography (GPC) and/or SEC (Size Exclusion Chromatography). The number-average molecular weight is generally determined by GPC-SEC.

The invention also achieves the object through a process for producing polyoxymethylene copolymers by polymerization of trioxane and optionally comonomers in the presence of at least one cationic initiator and of at least one di(C₁₋₆-alkyl)al as regulator, and through the polymers obtainable by said process.

The object is also achieved through use of the above polyoxymethylene copolymers as viscosity-modifying additive for polyoxymethylene homo- or copolymers with a weight-average molar mass of at least 50 000 g/mol.

### A BRIEF DESCRIPTION OF THE FIGURE

FIG. 1 attached shows the dependency of the size-exclusion-chromatography (SEC) detector signal in arbitrary units when plotted against molar mass in g/mol. The continuous line shows the molar mass distribution for mixing for one minute, the triangles show the molar mass distribution after mixing for 2 minutes, and the circles show the molar mass distribution for a mixing time of 5 minutes.

### A DETAILED DESCRIPTION OF THE INVENTION

It is preferable that the ratio between weight-average molecular weight (M_{W}) and number-average molecular weight (Mₙ), also termed polydispersity or M_{W}/Mₙ, is in the range from 1.5 to 3.0, preferably from 1.5 to 2.45.

Very generally, polyoxymethylene copolymers (POM) of the invention have at least 50 mol % of —CH₂O— repeat units in the main polymer chain. Preferred polyoxymethylene copolymers are those which also have, alongside the —CH₂O— repeat units, up to 50 mol %, preferably from 0.01 to 20 mol %, in particular from 0.1 to 10 mol %, and very particularly preferably from 0.5 to 6 mol %, of

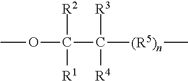

repeat units, where R¹ to R⁴ are mutually independently a hydrogen atom, a C₁-C₄-alkyl group, or a halogen-substituted alkyl group having from 1 to 4 carbon atoms, and R⁵ is —CH₂—, —CH₂O—, or a C₁-C₄-alkyl or C₁-C₄-haloalkyl-substituted methylene group, or a corresponding oxymethylene group, and n has a value in the range from 0 to 3. Said groups can advantageously be introduced into the copolymers through ring-opening of cyclic ethers. Preferred cyclic ethers are those of the formula

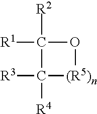

where R¹ to R⁵ and n are as defined above. Merely by way of example, ethylene oxide, propylene 1,2-oxide, butylene 1,2-oxide, butylene 1,3-oxide, 1,3-dioxane, 1,3-dioxolane, and 1,3-dioxepane (=butanediol formal, BUFO) may be mentioned as cyclic ethers, and linear oligo- or polyformals, such as polydioxolane or polydioxepane, may be mentioned as comonomers.

Equally suitable materials are oxymethylene terpolymers which by way of example are produced through reaction of trioxane or of one of the cyclic ethers described above with a third monomer, preferably bifunctional compounds, of the formula

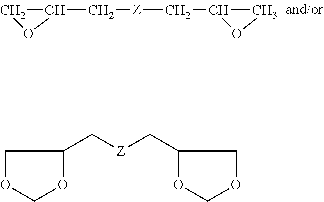

where Z is a chemical bond, —O—, —ORO— (R=C₁-C₈-alkylene or C₃-C₈-cycloalkylene).

Preferred monomers of this type are ethylene diglycide, diglycidyl ether, and diethers derived from glycidyl compounds and formaldehyde, dioxane, or trioxane in a molar ratio of 2:1, and also diethers made of 2 mol of glycidyl compound and 1 mol of an aliphatic diol having from 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol, to mention just a few examples.

Particular preference is given to end-group-stabilized polyoxymethylene polymers which have predominantly C—C or —O—CH₃ bonds at the chain ends.

At least 90% by weight of the polymers of the invention, based on the polymer, derives from trioxane and butanediol formal as monomers.

The polyoxymethylene copolymers here derive, preferably exclusively, from trioxane and butanediol formal as monomers, with a proportion of butanediol formal, based on the polymer or on the monomers, in the range from 0.5 to 4% by weight, preferred from 1 to 4% by weight, preferably from 2 to 3.5% by weight, in particular from 2.5 to 3% by weight.

The molecular weights of the polymer can be adjusted to the desired values by using the regulators conventionally used in trioxane polymerization or else by using the reaction temperature and reaction residence time. Regulators that can be used are acetals and, respectively, formals of monohydric alcohols, the alcohols themselves, and also the small amounts of water which are generally inevitably present and which function as chain-transfer agents.

It is preferable that the chain ends of the polymer of the invention have, based on the polymer, from 3 to 6% by weight of moieties of the general formula —OR, where R is C₁₋₆-alkyl, preferably C₁₋₄-alkyl.

It is preferable that production of the polyoxymethylene copolymers of the invention uses, based on the polymer or on the entirety of monomers and regulator, 3.75 to 4.25% by weight, preferably from 3.8 to 4.2% by weight, in particular from 3.9 to 4.1% by weight, of methylal, or an equimolar amount of another di(C₁₋₆-alkyl) acetal, concomitantly as regulator.

It is particularly preferable that, for example, on a laboratory scale, methylal is used concomitantly as regulator, or, for example industrially, that butylal (n-butylal) is used concomitantly as regulator.

It is particularly preferable to use butylal (n-butylal) as regulator which has the advantage of being nontoxic, whereas methylal classified as toxic. The use of butylal as regulator represents a further advantage in comparison with the polyoxymethylene copolymers known from U.S. Pat. No. 6,388,049.

It is therefore preferable that butylal is used as regulator during the production of the polymer. It is preferable to use an amount of from 0.5 to 4% by weight of butylal, based on the polymer, particularly from 1 to 3.5% by weight, in particular from 1.5 to 2.5% by weight.

In conjunction with this specific amount of comonomer and with the specific molecular weight, polyoxymethylene copolymers are obtained with particularly suitable mechanical properties which make them suitable as viscosity-modifying additive for polyoxymethylene homo- or copolymers with higher molecular weight, without any major impairment of mechanical properties, in particular hardness.

Particular preference is therefore given to polyoxymethylene copolymers with a proportion of butanediol formal, based on the polymer, in the range from 0.5 to 4% by weight, preferred 1 to 4% by weight, preferably from 2 to 3.5% by weight, in particular from 2.5 to 3% by weight, produced by using butylal in an amount, based on the polymer, of from 0.5 to 4% by weight, particularly preferably from 1 to 3.5% by weight, in particular from 1.5 to 2.5% by weight, concomitantly as regulator. The number average of the polyoxymethylene copolymer here is particularly preferably from 3000 to 6000 g/mol, more preferably from 3200 to 5000 g/mol, in particular from 3500 to 4100 g/mol.

This specific combination of molecular weight, proportion of comonomer, selection of comonomer, proportion of regulator, and selection of regulator leads to particularly suitable mechanical properties which permit the advantageous use as viscosity-modifying additive for higher-molecular-weight polyoxymethylene homo- or copolymers.

Initiators used (also termed catalysts) are the cationic initiators conventional in trioxane polymerization. Protic acids are suitable, for example fluorinated or chlorinated alkyl- and arylsulfonic acids, examples being perchloric acid and trifluoromethanesulfonic acid, or Lewis acids, e.g. tin tetrachloride, arsenic pentafluoride, phosphorus pentafluoride, and boron trifluoride, as also are their complex compounds and salt-like compounds, examples being boron trifluoride etherates and triphenylmethylene hexafluorophosphate. The amounts used of the initiators (catalysts) are about 0.01 to 1000 ppm, preferably 0.01 to 500 ppm, and in particular from 0.01 to 200 ppm. It is generally advisable to add the initiator in dilute form, preferably at concentrations of from 0.005 to 5% by weight. Solvents used for this purpose can be inert compounds, such as aliphatic or cycloaliphatic hydrocarbons, e.g. cyclohexane, halogenated aliphatic hydrocarbons, glycol ethers, etc. Triglyme (triethylene glycol dimethyl ether) and 1,4-dioxane are particularly preferred as solvents.

The invention particularly preferably uses, as cationic initiators, an amount in the range from 0.01 to 1 ppm (preferably from 0.02 to 0.2 ppm, in particular from 0.04 to 0.1 ppm), based on the entirety of monomers and regulator, of Brönsted acids. In particular, HClO₄ is used as cationic initiator.

In addition to the initiators, cocatalysts can be used concomitantly. These are alcohols of any type, examples being aliphatic alcohols having from 2 to 20 carbon atoms, such as tert-amyl alcohol, methanol, ethanol, propanol, butanol, pentanol, hexanol; aromatic alcohols having from 2 to 30 carbon atoms, such as hydroquinone; halogenated alcohols having from 2 to 20 carbon atoms, such as hexafluoroisopropanol; very particular preference is given to glycols of any type, in particular diethylene glycol and triethylene glycol; and aliphatic dihydroxy compounds, in particular diols having from 2 to 6 carbon atoms, such as 1,2-ethanediol, 1,3-propanediol, 1,4-butanediol, 1,6-hexanediol, 1,4-hexanediol, 1,4-cyclohexanediol, 1,4-cyclohexanedimethanol, and neopentyl glycol.

Monomers, initiators, cocatalyst, and optionally regulator can be premixed in any desired manner, or else can be added separately from one another to the polymerization reactor.

The components for stabilization can moreover comprise sterically hindered phenols, as described in EP-A 129369 or EP-A 128739.

The polyoxymethylene copolymers of the invention are produced by polymerization of trioxane, butanediol formal and optionally other comonomers in the presence of at least one cationic initiator and of at least one di(C₁₋₆-alkyl) acetal as regulator.

It is preferable that the polymerization mixture is deactivated, preferably without any phase change, directly after the polymerization reaction. The initiator residues (catalyst residues) are generally deactivated by adding deactivators (terminators) to the polymerization melt. Examples of suitable deactivators are ammonia, and also primary, secondary, or tertiary, aliphatic and aromatic amines, e.g. trialkylamines, such as triethylamine, or triacetonediamine. Other suitable compounds are salts which react as bases, for example soda and borax, and also the carbonates and hydroxides of the alkali metals and of the alkaline earth metals, and moreover also alcoholates, such as sodium ethanolate. The amounts of the deactivators usually added to the polymers are preferably from 0.01 ppmw (parts per million by weight) to 2% by weight. Preference is further given to alkyl compounds of alkali metals and of alkaline earth metals as deactivators, where these have from 2 to 30 carbon atoms in the alkyl moiety. Li, Mg, and Na may be mentioned as particularly preferred metals, and particular preference is given to n-butyllithium here.

In one embodiment of the invention, from 3 to 30 ppm, preferably from 5 to 20 ppm, in particular from 8 to 15 ppm, based on the entirety of monomers and regulator, of a chain terminator can be used concomitantly. Sodium methoxide is in particular used as chain terminator here.

POMs made of trioxane and butanediol formal are generally obtained by polymerization in bulk, and any reactors with a high level of mixing action can be used for this purpose. The reaction here can be conducted homogeneously, e.g. in a melt, or heterogeneously, e.g. as polymerization to give a solid or solid granules. Examples of suitable equipment are tray reactors, plowshare mixers, tubular reactors, list reactors, kneaders (e.g. Buss kneaders), extruders, for example those having one or two screws, and stirred reactors, and the reactors here may have static or dynamic mixers.

Trioxane polymerization can be separated theoretically into three reaction steps, initiation, propagation, and transfer reactions. During the transfer reactions, chain transfer can take place to the polymer, to a protic species, such as water, or to a transfer agent, such as butylal. The transfer reactions to other polymer chains permit random distribution of the comonomer units along the polymer chains. These reactions occur between the carbonium of an active chain and the oxygen of another polymer chain, as long as active carbonium ions are present in the reaction mixture.

Transfer reactions to protic species, such as water, reduce the molecular weight of the polymer and also its thermal stability, since unstable hydroxy end groups are formed. The polymerization reaction is therefore carried out under the driest possible conditions.

Transfer reactions to aprotic species, such as acetals with low molecular weight, reduce molecular weight and produce stable ether end groups, and therefore increase the thermal stability of the polymer. It is therefore preferable to use chain-transfer agents or regulators such as methylal or butylal, the desired amount of which is added to the monomer mixture. Butylal content in the POM used in conventional Catamold compositions is generally about 0.35% by weight, and the weight-average molar mass of the POM is about 97 000 g/mol, with a M_{W}/Mₙ ratio of about 4.2.

The POM polymerization reaction has no termination step. The living polymer is in equilibrium with formaldehyde monomer until the system arrives at a comonomer end group which represents a stable end group. A method for stabilizing the ends of the polymer here is therefore depolymerization of the unstable chain ends until only stable comonomer end groups remain. This method is used in the circulatory tray process, in which most of the resultant polymers have end groups derived from methylal or butylal (e.g. —O—(CH₂)₄—OH). The chain ends can also be deactivated by adding an alkaline compound. This procedure is used in particular in continuous processes in which living end groups are typically deactivated with sodium methanolate. The resultant polymer has a majority of —CH₂—O—CH₃— end groups.

In the case of polymerization in bulk, e.g. in an extruder, the molten polymer produces an effect known as melt-sealing, as a result of which volatile constituents remain in the extruder. At a preferred reaction-mixture temperature of from 62 to 114° C., the above monomers are metered, together with or separately from the initiators (catalysts) into the polymer melt present in the extruder. It is preferable that the monomers (trioxane) are also metered in the molten state, e.g. at from 60 to 120° C. Because the process is exothermic, it is usually only at the start of the process that the polymer in the extruder has to be melted; the amount of heat generated is then sufficient to melt the resultant POM polymer, or to keep it molten.

Polymerization in the melt generally takes place at from 1.5 to 500 bar and 130 to 300° C., and the residence time of the polymerization mixture in the reactor is usually from 0.1 to 20 min, preferably from 0.4 to 5 min. It is preferable to carry out the polymerization reaction until conversion is above 30%, e.g. from 60 to 90%.

A crude POM is often obtained which, as mentioned, comprises considerable proportions, for example up to 40%, of unreacted residual monomers, in particular trioxane and formaldehyde. It is possible that formaldehyde is present in the crude POM here even when only trioxane has been used as monomer, since it can arise as decomposition product of the trioxane. Other oligomers of formaldehyde can moreover also be present, e.g. the tetramer tetroxane.

Said crude POM is preferably devolatilized in one or more stages in known devolatilization apparatuses, for example in flash pots, vented extruders with one or more screws, thin-film evaporators, spray dryers, or other conventional devolatilization apparatuses. Flash pots are particularly preferred.

In a preferred method for the devolatilization of the crude POM, the material is devolatilized to below 6 bar absolute in a first flash, giving a gaseous stream and a liquid stream which is passed onward to a second flash operated at below 2 bar absolute to give a vapor stream which is recycled into the monomer plant.

By way of example, in the case of two-stage devolatilization, the pressure in the first stage can preferably be from 2 to 18 bar, in particular from 2 to 15 bar, and particularly preferably from 2 to 10 bar, and the pressure in the second stage can preferably be from 1.05 to 4 bar, in particular from 1.05 to 3.05 bar, and particularly preferably from 1.05 to 3 bar.

The partially devolatilized polyoxymethylene homo- or copolymer can then be introduced into an extruder or kneader and provided therein with conventional additional materials and processing aids (additives) in the amounts conventional for these substances. Examples of additives of this type are lubricants or mold-release agents, colorants, e.g. pigments or dyes, flame retardants, antioxidants, light stabilizers, formaldehyde scavengers, polyamides, nucleating agents, fibrous and pulverulent fillers or fibrous and pulverulent reinforcing materials, or antistatic agents, and also other additional materials or a mixture of these.

POM in the form of finished product is obtained as melt from the extruder or kneader.

The preferred batch synthesis using the circulatory tray process includes the following steps:

In the first step, the liquid monomer/comonomer mixture is charged to an unsealed reaction vessel (“tray”). Initiator is introduced through a pump, for example an HPLC pump, at a temperature in a range which is preferably from 60 to 100° C., particularly preferably from 70 to 90° C., in particular from 75 to 85° C. A solvent of boiling point above 100° C., miscible with the monomers, can be used concomitantly.

In the second step, the initiator, preferably aqueous HClO₄, is mixed in a solvent with the monomers.

In the third step, after an induction time, polymerization and crystallization take place simultaneously, and when these end the product of the homogeneous reaction is a solid block of polymer. The induction time here is often less than 120 seconds, for example from 20 to 60 seconds.

In the fourth step, the solid crude POM is removed from the tray, comminuted mechanically, and further processed in an extruder in order, for example, to obtain stable end groups through depolymerization (devolatilization). Stabilizers and other ingredients can also be metered into the material. A mixture which can be considered to be a standard stabilizer mixture is composed of antioxidant, acid scavenger, and nucleating agent.

Once the reaction vessel has been emptied, liquid monomer can again be charged thereto, in order to begin a new circuit.

In contrast to the process of the invention, the production of the POM copolymers in U.S. Pat. No. 6,388,049 is carried out in the fully molten state in tubular reactors. The production of the blend takes place in two reactors connected in series.

The resultant polymer can by way of example be milled to give a coarse powder, sprayed with a buffer solution, and then introduced into the extruder. The buffer serves to neutralize residual acids in the melt.

For successful conduct of the circulatory tray process, the synthesis should be rapid, i.e. have a short induction period. The oligomers obtained should moreover be hardened rapidly and completely during the polymerization reaction, and should form a block of polymer which does not adhere excessively to the vessel wall.

The low-molecular-weight POM can be produced particularly advantageously by using a small amount of initiator, a large amount of regulator, and capping the chain ends. The resultant POM with low molecular weight is not only heat-resistant but also chemicals-resistant, and its viscosity can be lower by a factor of up to 1000 when it is compared with a conventional POM with high molecular weight, as used hitherto in Catamold compositions.

When the low-molecular-weight POM is used as viscosity-modifying additive for POM with a weight-average molar mass of at least 50 000 g/mol, preferably at least 80 000 g/mol, the addition gives a POM system which is thermally and chemically stable and the viscosity of which can be reduced by a factor of at least 10, without significantly impairing the mechanical strength of the high-molecular-weight POM.

The examples below provide further explanation of the invention.

### EXAMPLES

Production of the POM Oligomers

Laboratory-scale polymerization was carried out in a process which simulates the circulatory tray process. The monomers and the regulator were heated to 80° C. in open iron or aluminum reactors, with magnetic stirring. The mixture here was a transparent liquid. At a juncture t=0, an initiator solution was injected, composed of HClO₄ in triglyme, having a proton concentration which is typically 5 ppm relative to the monomers, or correspondingly lower for the low-molecular-weight POM. When polymerization was successful, the mixture became cloudy within a short time (induction period typically in the region of a few seconds to one minute) and the polymer precipitated.

Posttreatment and Determination of Weight Loss

The resultant block of polymer was then milled to give a powder and heated at reflux for one hour in an extraction solution made of methanol, water, and sodium carbonate. After cooling, the polymer was isolated by filtration and washed with a wash solution of aqueous sodium carbonate. The powder was then dried, and the weight loss was determined. This method gives an indication of the polymerization yield, since residual monomers or very low-molecular-weight oligomers are extracted in this step. The living centers of the crude polymer chains, and also residual acid centers, are to some extent extracted or neutralized. All of the cations should be neutralized, in order to obtain a polymer which has sufficient stability for further investigation or further processing. Otherwise acid residues would shift the equilibrium in the direction of formaldehyde and impair thermal stability.

Investigation of Thermal Stability

A few grams of the extracted and dried polymer were heated under nitrogen to 220° C. After four hours, the weight loss from the polymer was determined. The result indicates how many unstable end groups are comprised by the polymer, affected by the amount and distribution of the comonomers along the polymer chain, and also by the amount of regulator.

Thermal Stability
WL N₂: weight loss (WL) in percent from a specimen composed of 1.2 g of pellets on heating to 222° C. in nitrogen for 2 hours.

At the start of the WL determination process, the balance used for this purpose was tared. The specimen, in a twin-walled vessel composed of two test tubes, one placed inside the other (normal test tube, 100×10 mm; specially prepared, thick-walled test tube, 100×12.5 mm) was weighed out with accuracy of 0.1 mg.

A thin copper wire of length about 400 mm was secured to the upper lip of the outer tube. This was used to suspend the twin-walled vessels in a specific apparatus (see FIG. 9 and the relevant description of the figures in WO 2006/074997). For WL determination in nitrogen, the upper half of the apparatus was used for 15 min. for adaptation to the specific atmosphere, i.e. with no temperature increase. The test tubes were then lowered onto the base, where they were kept at 222° C. for 2 h. The nitrogen flow rate was 15 l/h, checked with the aid of a rota for each individual test tube.

After expiry of 2 h, the twin-walled vessels were withdrawn from the apparatus with the aid of the copper wire and cooled in air for from 20 to 25 min. The weight was then again measured on the balance, and WL was calculated from

WL[%]=(Loss×100/initial weight).

Molar Mass Determination

The molar masses of the polymers were determined via size-exclusion chromatography in an SEC apparatus. This SEC apparatus was composed of the following combination of separating columns: a preliminary column of length 5 cm and diameter 7.5 mm, a second linear column of length 30 cm and diameter 7.5 mm. The separating material in both columns was PL-HFIP gel from Polymer Laboratories. The detector used comprised a differential refractometer from Agilent G1362 A. A mixture composed of hexafluoroisopropanol with 0.05% of potassium trifluoroacetate was used as eluent. The flow rate was 0.5 ml/min, the column temperature being 40° C. 60 microliters of a solution at a concentration of 1.5 g of specimen per liter of eluent were injected. This specimen solution had been filtered in advance through Millipor Millex GF (pore width 0.2 micrometer). Narrowly distributed PMMA standards from PSS (Mainz, Del.) with molar masses M from 505 to 2 740 000 g/mol were used for calibration.

Tensile modulus of elasticity (modulus of elasticity) was determined in accordance with ISO 527 (23° C., 1 mm/min).

Yield stress, tensile strain at yield, tensile stress at break, and tensile strain at break were determined in accordance with ISO 527 (23° C., 50 mm/min).

Charpy notched impact resistance was determined in accordance with ISO 179 1eA (F) (23° C., 2.9 m/s).

Charpy impact resistance (without notch) was determined in accordance with ISO 179 1eA (U) (23° C., 2.9 m/s).

Reactions Using Butylal as Regulator

Table 1 below lists the commercially available POMs marketed with trademark Ultraform® by BASF SE and produced by the circulatory tray process.

TABLE 1

| | Butylal | | | | |
|---|---|---|---|---|---|
| | content | Mn | Mw | | MFI |
| Name | [% by wt.] | [×10³ g/mol] | [×10³ g/mol] | Mw/Mn | [cm³/10 min] |
| H2320 | 0.1 | 27 | 209 | 7.7 | 2.1-2.4 |
| N2320 | 0.17 | 26 | 154 | 5.9 | 7.3-7.7 |
| S2320 | 0.2 | 25 | 135 | 5.4 | 9-12 |
| W2320 | 0.25 | 22 | 109 | 5.0 | 23-25 |
| Z2320 | 0.35 | 23 | 97 | 4.2 | 42-43 |

The POM used for the Catamold process described in the introduction corresponds to Ultraform® Z2320, which is produced with 0.35% by weight butylal content.

The proportion of butylal was then increased in order to reduce molecular weight. The proportion of butanediol formal comonomer was in each case unchanged at 2.7% by weight, based on the polymer. Initiator concentration was 0.2 ppm, based on the monomers.

Table 2 below collates the results.

TABLE 2

| | Butylal, | | Mn | | Mw/ | | Thermal |
|---|---|---|---|---|---|---|---|
| | % by | Induction | [g/ | Mw | Mn | Extraction | stability, |
| Ex. | wt. | time | mol] | [g/mol] | [—] | [%] | Stab. [%] |
| 1 | 3 | 8 | 6080 | 15 800 | 2.4 | 7.23 | 4.5 |
| 2 | 4 | 7 | 5350 | 12 700 | 2.4 | 3.56 | 4.3 |
| 3 | 4.5 | 9 | 4700 | 11 000 | 2.4 | 1.8 | 3.8 |
| 4 | 5.00 | 15 | 3940 | 8160 | 2.2 | 7.62 | 1.9 |
| 5 | 5.50 | 20 | 3640 | 7580 | 2.1 | 9.65 | 5.0 |

The proportion of butylol was then maintained at 5.5% by weight in order to reduce molecular weight. The proportion of butanediol comonomer was changed. Initiator concentration was 0.05 ppm, based on the monomers.

TABLE 3

| | Bufo, | | | | Mw/ | | Thermal |
|---|---|---|---|---|---|---|---|
| | % by | Induction | Mn | Mw | Mn | Extraction | stability, |
| Ex. | wt. | time | [g/mol] | [g/mol] | [—] | [%] | Stab. [%] |
| 6 | 0.5 | 23 | 4690 | 10 700 | 2.2 | 9.01 | 4.96 |
| 7 | 1 | 28 | 4580 | 10 400 | 2.3 | 7.02 | 5.62 |
| 8 | 3.7 | 21 | 4850 | 11 000 | 2.3 | 7.91 | 5.99 |

Bufo: butanediol formal

Reaction with Methylal as Regulator

The above process was repeated with the use of methylal as regulator. The best results were achieved with an amount of about 4.0% by weight of methylal, which is close to the molar equivalent of 5.5% by weight of butylal. However, the induction time was markedly higher than for butylal. Table 4 below collates the results. Butanediol comonomer content was again 2.7% by weight. Initiator concentration was 0.05 ppm, based on the monomers.

TABLE 4

| | | | | | Mw/ | Ex- | Thermal |
|---|---|---|---|---|---|---|---|
| | Methylal | Induction | Mn | Mw | Mn | traction | Stab. |
| Ex. | [% by wt.] | time | [g/mol] | [g/mol] | [—] | [%] | [%] |
| 9 | 3.0 | 55 | 29 700 | 271 000 | 9.1 | 12 | 7.4 |
| 10 | 4.0 | 88 | 3680 | 7090 | 1.9 | 13.6 | 7.3 |

Rheology Investigations

Rheology investigations were carried out on the standard Ultraform products and on the POM of the invention as in Example 2. For this, a plate-on-plate rheometer was used at 190° C., and dynamic viscosity was determined as a function of shear rate.

Table 5 below collates the results.

TABLE 5

| | | | | | After |
|---|---|---|---|---|---|
| | | | | | restart/ |
| Speci- | Mw | First measurement | | After restart | first |
| men/ | [×.10³ | H₀* | h*_{(@ w~10 rad/s)} | h*_{(@ w~10 rad/s)} | measure- |
| Ex. | g/mol] | [Pa-s] | [Pa-s] | [Pa-s] | ment (%) |
| Z2320 | 97 | 186 | 185 | 178 | −3.8 |
| N2320 | 154 | 1000 | 961 | 940 | −2.2 |
| H2320 | 210 | 3010 | 2610 | 2530 | −2.9 |
| 2 | 12.7 | 0.11 | 0.12 | 0.12 | −1.6 |
| 3 | 11 | 0.11 | 0.11 | 0.11 | 0.8 |

The oligomers of the invention have very low melt viscosity.

Extrusion of POM Blends

Blends made of various Ultraform® POM polymers with different proportions of low-molecular-weight POM oligomers from Examples 1 to 8 were extruded at 190° C. for two minutes in a midi-extruder. Table 6 below collates the resultant blend properties determined from GPC measurements.

TABLE 6

| | High molecular | | | | | Blend properties | | |
|---|---|---|---|---|---|---|---|---|
| | weight POM | | Oligomers POM | | | | | Mw/ |
| | | Mw | | Mw | [% by | Mn | Mw | Mn |
| Ex. | Name | [g/mol] | Ex. | [g/mol] | weight] | [g/mol] | [g/mol] | [—] |
| 12 | Z2320- | 86.000 | 1 | 15.800 | 50 | 10.320 | 56.200 | 5.4 |
| 13 | 0035 | | | | 83 | 7.809 | 31.280 | 4 |
| 14 | | | 2 | 12.700 | 50 | 8.983 | 54.160 | 6 |
| 15 | | | | | 83 | 6.417 | 27.200 | 4.2 |
| 16 | | | 3 | 11.000 | 50 | 8.108 | 54.640 | 6.7 |
| 17 | | | | | 83 | 5.692 | 23.915 | 4.2 |
| 18 | | | 4 | 8.160 | 50 | 6.610 | 45.800 | 6.9 |
| 19 | | | 5 | 7.580 | 50 | 6.540 | 45.100 | 6.9 |
| 20 | | | 6 | 10.700 | 10 | 17.900 | 75.700 | 7.2 |
| 21 | | | 7 | 10.400 | 10 | 19.600 | 76.400 | 3.9 |
| 22 | | | 8 | 11.000 | 10 | 18.600 | 75.400 | 4.1 |
| 23 | S2320- | 131.000 | 3 | 11.000 | 50 | 7.374 | 65.410 | 8.9 |
| 24 | 003 | | | | 83 | 5.575 | 36.890 | 6.6 |
| 25 | S1320- | 128.800 | 3 | 11.000 | 5 | 21.570 | 124.400 | 5.4 |
| | 003 | | | | | | | |
| 26 | N2320- | 138.200 | 3 | 11.000 | 5 | 21.860 | 137.600 | 6.3 |
| | 003 | | | | | | | |
| 27 | N2320- | 143.600 | 3 | 11.000 | 5 | 24.470 | 133.700 | 5.5 |
| | 0038 | | | | | | | |
| 28 | H2320- | 191.000 | 3 | 11.000 | 5 | 22.370 | 181.100 | 8.1 |
| | 006 | | | | | | | |
| 29 | H4320- | 208.000 | 3 | 11.000 | 50 | 7.535 | 103.300 | 13.7 |
| 30 | 003 | | | | 83 | 4.911 | 24.920 | 5.1 |

The blends were likewise subjected to the above rheology measurements. Table 7 below collates the results.

TABLE 7

| | h*_{(@ w~10 rad/s)} |
|---|---|
| Specimen/Ex.. | [Pa-s] |
| 12 | 24.6 |
| 13 | 2.4 |
| 14 | 24.6 |
| 15 | 1.4 |
| 16 | 23.2 |
| 17 | 1.3 |
| 18 | 12.4 |
| 19 | 11.9 |
| 20 | 72.8 |
| 21 | 73.4 |
| 22 | 74.5 |
| 23 | 87.1 |
| 24 | 4 |
| 25 | 662 |
| 26 | 940 |
| 27 | 714 |
| 28 | 2491.9 |
| 29 | 552.6 |
| 30 | 17.2 |

The low-molecular-weight POMs of the invention can therefore be used with particular advantage as viscosity-modifying additive for polyoxymethylene homo- or copolymers with a weight-average molar mass of at least 50 000 g/mol.

The low-molecular-weight POMs of the invention are chemically and mechanically stable and do not reduce either overall strength or overall mechanical properties on mixing with high-molecular-weight POM. The viscosity of the high-molecular-weight POM can be reduced greatly here, and this effect is retained through a plurality of melt passes.

No formaldehyde vapor is evolved, and the POM blend remains solid, and it is therefore also possible to carry out the traditional Catamold production process with the POM blends.

These advantages are not achieved with the use of compounds of even lower molecular weight, for example POM dimethyl ethers, such as Me-O—(CH₂O)₄-Me. The advantages mentioned are achieved only by the specific use of the POM of the invention.

In another experiment, in Example 12, blends made of Ultraform® 22320 with low-molecular-weight POM oligomer from Example 4 were mixed in a mini extruder in a ratio by weight of 50:50. 3 specimens were mixed here for one minute, 2 minutes and, respectively, 5 minutes.

Size-exclusion chromatography was then used in each case to plot a molecular-weight profile for the blend.

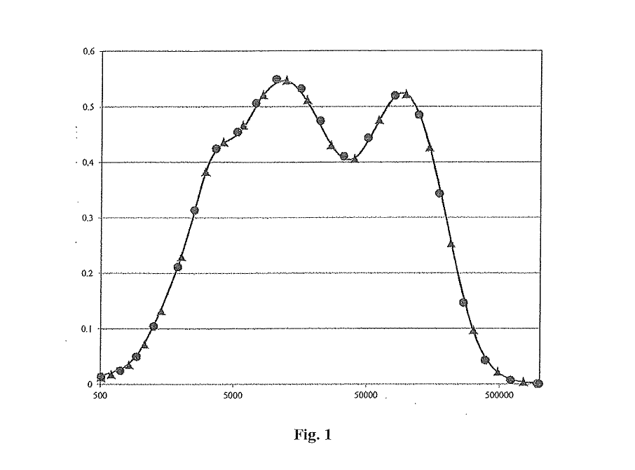

FIG. 1 attached shows the dependency of the size-exclusion-chromatography (SEC) detector signal in arbitrary units when plotted against molar mass in g/mol. The continuous line shows the molar mass distribution for mixing for one minute, the triangles show the molar mass distribution after mixing for 2 minutes, and the circles show the molar mass distribution for a mixing time of 5 minutes.

The molar mass distribution was found to remain the same for the three mixing times, indicating stability of the polymer blend. The bimodal molar mass distribution resulting from the blend polymers is moreover retained. There is therefore no molar mass equilibration through transacetalization.

In another experiment, complex shear viscosities were investigated for blends made of Ultraform® Z2320 with POM oligomers from Example 4 in a ratio of 50:50 by weight. The investigation used rotation rheology at a shear rate of 10 rad/s. Whereas Ultraform® Z2320 exhibited a complex shear viscosity of about 100 Pa·s, the complex shear viscosity for the blend of the invention with the POM oligomer from Example 4 was about 17 Pa·s. The blends with the low-molecular-weight POM therefore exhibit a preferred low shear viscosity.

It can therefore be stated that the bimodal molar mass distribution of the POM blends is retained even after thermal stress and that there is a major reduction in shear viscosity, and that processing properties are therefore markedly improved. The improved flowability in particular means that long flow paths and low wall thicknesses can also be tolerated in the injection-molding process, with no impairment of the result.

In contrast to other flow improvers, no phase separation occurs under shear when the POM oligomers are added, and neither therefore does any exudation of the flow improver occur which in turn would cause deposits in the mold.

The combination of low-molecular-weight POM with high-molecular-weight POM does not make the moldings brittle, but gives them high strength.

The stability in the melt makes the POM blends advantageously suitable for the Catamold® process for injection molding of metal powder or of ceramic powder. In this process, the POM molding compositions are subjected to three melting and shearing procedures, during mixing of the two polymer components, during introduction of the metal powder or ceramic powder, and finally during injection molding. Further thermal stress occurs during return and reuse of parts of the injection-molded products, for example the sprues. This is where the advantages mentioned for the POM systems of the invention become apparent.

Polymer particles marketed with trademark Catamold® comprise inorganic powders, in particular metal powders or ceramic powders. Typically, these powders are first coated with a thin layer of polyethylene and then are compounded into a polyoxymethylene binder. These Catamold granules are then processed by injection molding to give a green product, converted to a brown product by removal of binder, and then sintered to give a sintered molding. The process is known as metal injection molding (MIM) and permits production of metallic or ceramic moldings with complex shapes.

The proportion of inorganic fillers in the Catamold granules is about 90% by weight.

The green products produced with use of polyoxymethylene homo- or copolymers have very good mechanical properties, in particular dimensional stability.

Binder removal is often achieved through exposure to an acidic atmosphere, for example HNO₃ atmosphere, at from 110 to 140° C., with decomposition of the POM binder. The thin polyethylene coating of the inorganic particles binds these to one another in the brown product obtained. The acidic depolymerization of the POM permits complete removal of the binder.

The brown product is preferably sintered in a sintering oven at temperatures in the range of about 1100 to 1500° C., to give the desired metal molding or ceramic molding.

The better the flowability of the filled polyoxymethylene homo- or copolymer compositions, the finer the structures that can be developed in the molding. On the other hand, the metal particles or ceramic particles have to be capable of homogeneous transportation with the molding composition. A suitable property profile involving flowability and creep compliance is often achieved by using POM with a weight-average molar mass starting at about 85 000 g/mol.

The addition of a low-molecular-weight POM component to the high-molecular-weight material Ultraform® not only changes viscosity, as observed, but also increases the stiffness of the material. These changes are apparent from table 8 below.

TABLE 8

| | | | | | | | Charpy |
|---|---|---|---|---|---|---|---|
| | | | | | | Charpy | impact |
| | Modulus | | Tensile | Tensile | Tensile | notched | resistance |
| | of | Yield | strain at | stress at | strain at | impact | (without |
| | elasticity | stress | yield | break | break | resistance | notch) |
| Example | (MPa) | (MPa) | (%) | (MPa) | (%) | (kJ/m²) | (kJ/m²) |
| S1320-003 | 2791 | 67.01 | 10.91 | 64.48 | 20.2 | 4.14 | 180 |
| 18 | 2875 | 66.7 | 9.07 | 63.7 | 20.15 | 3.85 | 160 |
| N2320-003 | 2753 | 64.45 | 9.45 | 55.77 | 29.56 | 6 | 229 |
| 19 | 2837 | 64.67 | 8.55 | 54.98 | 30.93 | 5.43 | 186 |
| H2320-006 | 2517 | 58.76 | 11.83 | 63.95 | 29.74 | 6.4 | 229 |
| 21 | 2577 | 59.51 | 10.9 | 63.79 | 27.39 | 6.14 | 254 |

Interestingly, in some instances the stiffness increase is accompanied by an increase in the impact resistance. This demonstrates the additional advantage of the use of low-molecular-weight POM as additive for improving not only hardness but also other mechanical properties.

1-14. (canceled)

15. A polyoxymethylene copolymer with a weight-average molar mass (M_{W}) in the range from 5000 to 15 000 g/mol, at least 90% by weight of which, based on the polymer, derives from trioxane and butanediol formal as monomers, with a proportion of butanediol formal, based on the polymer, in the range from 0.5 to 4% by weight.

16. The polymer according to claim 15, wherein the weight-average molar mass (M_{W}) is from 6000 to 9000 g/mol.

17. The polymer according to claim 15, wherein the number-average molar mass (Mₙ) is from 3000 to 6000 g/mol.

18. The polymer according to claim 15, wherein the M_{W}/Mₙ ratio is in the range from 1.5 to 3.0.

19. The polymer according to claim 15, wherein with the proportion of butanediol formal, based on the polymer, in the range from 2.5 to 3% by weight, the weight-average molar mass (M_{W}) is from 7000 to 7500 g/mol and the number-average molar mass (Mₙ) is from 3500 to 4100 g/mol.

20. The polymer according to claim 15, wherein the M_{W}/Mₙ ratio is in the range from 1.5 to 3.0.

21. The polymer according to claim 19, wherein the M_{W}/Mₙ ratio is in the range from 1.5 to 2.45.

22. The polymer according to claim 15, which derives exclusively from trioxane and butanediol formal as monomers.

23. The polymer according to claim 15, which has, at the chain ends, based on the polymer, from 3 to 6% by weight of moieties of the formula —OR, where R is C₁₋₆-alkyl.

24. The polymer according to claim 23, wherein production of the polymer uses, based on the polymer, from 3.75 to 4.25% by weight, of methylal, or an equimolar amount of another di(C₁₋₆-alkyl) acetal, concomitantly as regulator.

25. The polymer according to claim 23, wherein production of the polymer uses butylal, in an amount, based on the polymer, of from 0.5 to 4% by weight, concomitantly as regulator.

26. The polymer according to claim 23, wherein production of the polymer uses, based on the polymer, from 3.9 to 4.1% by weight, of methylal, or an equimolar amount of another di(C₁₋₆-alkyl) acetal, concomitantly as regulator.

27. The polymer according to claim 23, wherein production of the polymer uses butylal, in an amount, based on the polymer, of from 1.5 to 2.5% by weight, concomitantly as regulator.

28. A process for producing the polyoxymethylene copolymer according to claim 15 which comprises polymerization of trioxane and optionally comonomers in the presence of at least one cationic initiator and of at least one di(C₁₋₆-alkyl) acetal as regulator.

29. The process according to claim 28, which uses, based on the entirety of monomers and regulator, 3.75 to 4.25% by weight, of methylal, or from 0.4 to 4% by weight, of butylal, or an equimolar amount of another di(C₁₋₆-alkyl) acetal, concomitantly as regulator.

30. The process according to claim 28, which uses, as cationic initiator, an amount in the range from 0.01 to 1 ppm, based on the entirety of monomers and regulator, of a Brönsted acid.

31. The process according to claim 28, which uses, based on the entirety of monomers and regulator, 3.9 to 4.1% by weight, of methylal, or from 1.5 to 2.5% by weight, of butylal, or an equimolar amount of another di(C₁₋₆-alkyl) acetal, concomitantly as regulator.

32. The process according to claim 28, which uses, as cationic initiator, an amount in the range from 0.04 to 0.1 ppm, based on the entirety of monomers and regulator, of a Brönsted acid.

33. The process according to claim 28, which uses methylal and/or butylal as regulator.

34. The process according to claim 28, which uses from 3 to 30 ppm based on the entirety of monomers and regulator, of a chain terminator concomitantly.

35. A polyoxymethylene copolymer obtainable by the process according to claim 28.
